(19) United States
(12) Patent Application Publication
(10) Pub. No.: US 2020/0011666 A1
(43) Pub. Date: Jan. 9, 2020

(54) VIBRATORY GYROSCOPE UTILIZING THE NONLINEAR MODAL INTERACTION

(71) Applicant: Simon Fraser University, Burnaby (CA)

(72) Inventors: Farid Golnaraghi, Surrey (CA); Behraad Bahreyni, Port Moody (CA); Amr Marzouk, Burnaby (CA); Atabak Sarrafan, Vancouver (CA); S. Amir Mousavi Lajimi, Waterloo (CA); Oldooz Pooyanfar, Vancouver (CA); Navid Noori, Surrey (CA)

(73) Assignee: Simon Fraser University, Burnaby (CA)

(21) Appl. No.: 16/557,841

(22) Filed: Aug. 30, 2019

Related U.S. Application Data
(63) Continuation of application No. 15/799,922, filed on Oct. 31, 2017, now abandoned.
Application No. 15/799,922 is a continuation of application No. PCT/CA2016/050534, filed on May 9, 2016.
(60) Provisional application No. 62/159,054, filed on May 8, 2015.

(51) Int. Cl. G01C 19/5656; G01C 19/5649

(52) U.S. Cl. CPC G01C 19/5656; G01C 19/5649

(57) ABSTRACT

The disclosed devices utilize nonlinearly coupled modes of vibration to provide robust inertial sensors, such as gyroscopes. This actuation mechanism introduces a wider bandwidth in the sense-mode frequency response curve, and consequently enhances robustness to parameter fluctuations due to operating conditions and fabrication imperfections. The vibratory modes of the device are designed to have distinct frequencies where the drive-mode natural frequency is twice the modal frequency of the sense mode. The nonlinear modal interaction due to internal resonance can also be magnified through nonlinearity feedback. The sense mode response can be enhanced in shape, quality factor, and bandwidth by feeding back nonlinear quadratic, cubic, etc. terms.

### CROSS-REFERENCES TO RELATED APPLICATIONS

This application is a continuation of U.S. Non-Provisional application Ser. No. 15/799,922, filed Oct. 31, 2017, which is continuation of International Application No. PCT/CA2016/050534, filed May 9, 2016, which claims the benefit of U.S. Provisional Application No. 62/159,054, filed May 8, 2015, the disclosures of which are expressly incorporated herein by reference in their entirety.

### BACKGROUND

The transfer of energy between directly excited modes of vibration and indirectly excited modes via internal resonance (IR) is a result of nonlinear modal interaction. Internal resonance exists when the linear natural frequencies of a system are commensurable, or nearly commensurable, and nonlinear terms couples the structural modes. For example, in a two degree-of-freedom (DOF) system if the linear natural frequencies are defined as ω₁ and ω₂, IR occurs through quadratic nonlinearities when ω₁≈2ω₂ or ω₂≈2ω₁. Internal resonance occurs as a result of nonlinearities present in the system and leads to energy transfer among the system modes. The amount of energy that is transferred depends on the type of nonlinearity (i.e., quadratic or cubic nonlinear terms, which exhibits in equations of motion). Nonlinear quadratic coupling terms cause auto-parametric excitation of lower natural frequency mode by higher natural frequency mode. Internal resonance can occur in any physical system, depending on the geometry and nonlinear terms.

One application area that can benefit from IR unique characteristics is inertial measurement. Currently, many of the efforts in inertial sensor development are oriented toward improving precision and accuracy of micromachined gyroscopes, which are used for the most critical and precision-demanding applications (e.g., military, tactical/inertial navigation, and space applications).

Conventional gyroscopes operate in linear regime where there is always a trade-off between the signal amplitude (quality factor Q) and the bandwidth (BW) of operation. In order to achieve high sensitivity, the drive and sense resonant frequencies are typically designed and tuned to match and the device is controlled to operate at or near the peak of the response curves. A system that requires this mode-matching requirement is sensitive to parameter variations due to fabrication imperfections and operating conditions. Internal resonance can be utilized to improve performance and enhance robustness of gyroscopes to parameter fluctuations in operating conditions and fabrication imperfections.

To further improve the gain of the response and enhance the frequency bandwidth, the examination of characteristics of nonlinearly coupled terms is applicable. The quadratic and cubic nonlinear terms for instance can be fed back to the system generating a wider bandwidth where the shape of the flat region of the response is also improved.

As an example of the control-based solutions, Brand et al. disclosed a gyroscope design based on frequency-modulation where the frequency of vibration varies with the input rotation rate. Sonmezogl et al. utilize a complex electronic circuit to increase the bandwidth and sensitivity of a traditional amplitude-modulation mode-matched gyroscope.

Examples of the mechanical-based approach to solve the mode-matching solution were presented by Acar et al. and Trusov et al. In the aforementioned disclosures, multiple proof-masses were introduced to widen the bandwidth and thereby increase gyroscope robustness. However, this approach resulted in an overly complex mechanical design. Vyas et al. disclose a resonator and mass sensor employing internal resonance for a higher sensitivity.

Despite recent advances, further development of vibratory gyroscopes is desirable in order to optimize current applications and expand into new ones.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, device configured to measure angular movement around at least one axis is provided, including:

a structure having two distinct vibration modes that are nonlinearly coupled: a sense mode with sense mode frequency fₛₑₙₛₑ and a drive mode with drive mode frequency f_{drive};

a vibration source configured to produce vibrations in the mass at the drive mode; and

a vibration detector configured to detect vibrations of the sense mode.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic of the principle structure of the internally resonant Coriolis vibratory gyroscope, in accordance with embodiments disclosed herein;

FIG. 2 is a diagram of a lumped mass-spring-damper model of internally resonant Coriolis vibratory gyroscope, such as that of FIG. 1, in accordance with embodiments disclosed herein;

FIG. 3A is a schematic representation of the structure shown in FIG. 1, showing the first mode of vibration;

FIG. 3B is a schematic representation of the structure shown in FIG. 1, showing the second mode of vibration;

FIG. 4 is a schematic representation showing the experimental set-up for gyroscope testing;

FIG. 5 is a graph which illustrates the experimental and simulation results of exemplary gyroscope sense-mode response showing a raise in the vibrational energy in the sense direction due to 2:1 internal resonance;

FIG. 6 is a graph which illustrates the bandwidth and gain enhancement of the detuned internally resonant gyroscope structure;

FIG. 7A is a schematic of a MEMS T-structure utilizing the internal resonance, in accordance with embodiments disclosed herein;

FIG. 7B illustrates the simulated frequency responses of sense mode of a 2:1 internal resonance for the MEMS structure of FIG. 7A;

FIG. 7C illustrates the experimental frequency response of the sense mode of a 2:1 internal resonance for the MEMS structure of FIG. 7A;

FIG. 8A is a schematic of a gyroscope structure utilizing internal resonance, in accordance with embodiments disclosed herein;

FIG. 8B illustrates the simulated responses of drive and sense mode as a function of time, showing a loss in the vibrational energy in the drive and an increase in the energy of the sense due to 2:1 internal resonance for the MEMS structure of FIG. 8A;

FIG. 9A is a schematic of a gyroscope structure utilizing internal resonance, in accordance with embodiments disclosed herein;

FIG. 9B illustrates the simulated responses of drive and sense mode as a function of time, showing a loss in the vibrational energy in the drive and an increase in the energy of the sense due to 2:1 internal resonance for the MEMS structure of FIG. 9A;

FIG. 10A is a schematic of a gyroscope structure utilizing the internal resonance base on the design in FIG. 1; and

FIG. 10B illustrates the experimental frequency response of the sense mode for the 2:1 internal resonant MEMS structure of FIG. 10A.

### DETAILED DESCRIPTION

The disclosed embodiments relate to micromachined inertial sensors, such as Coriolis vibratory gyroscopes (CVG), measuring input rotation rate based on modulated excitation amplitude and nonlinear dynamics. Certain disclosed embodiments additional related to nonlinear feedback for enhancement of bandwidth and quality factor.

In summary, the disclosed embodiments use nonlinear dynamic characteristics of an internally coupled resonant system in the design of an inertial sensor. As a representative embodiment, sample macro- and micro-device designs based on internal resonance are disclosed and described herein. As an example, the internal resonance of the device is used to achieve large oscillation amplitude when measuring the displacement induced by the Coriolis force at the frequency of the drive mode. In one embodiment, the system includes a primary beam, an actuating drive mechanism, a secondary beam, and a sense mechanism. In order to achieve a state of internal resonance, the drive mode and the sense mode are mechanically coupled. The frequency response of the sense mode has two peaks, wherein the larger peak appears around the drive mode's natural frequency. This phenomenon causes a relatively flat region response of the sense beam at the drive mode's frequency offering a higher bandwidth.

By using the internal resonance phenomena, the drive and sense modes no longer require a 1:1 ratio (mode-matching requirement), as it is common in most other resonators and Coriolis vibratory gyroscopes. As a result, the frequencies of the drive and the sense modes are separated (for example, the drive frequency is twice higher than the sense frequency—i.e. a 2:1 internal resonance), the sensed signal can be filtered for frequencies up to near the frequency of the drive mode, reducing noise effects around the natural frequency of the sensed mode. A considerable improvement in the long-term stability of the sensor is achieved by reducing the effects of electronic noise on the readout circuit, thereby improving the sensitivity of the sensor. A larger sensitivity increases the quality factory, scaling down the effect of noise, which is of great benefit.

The drive mode is excited by employing a driving mechanism and the sense mode is sensed using a sensing mechanism. In an embodiment, a macro-scale example, the actuating mechanism includes two piezo-ceramic patches (attached to the drive beam) and the sensing mechanism is a strain gauge attached near the root of the sense beam. In another embodiment, a micro-scale example, the actuating and sensing mechanisms are provided through electrostatic actuation and capacitive sensing, respectively.

The drive and sense mode oscillators can be run in a closed-loop to actively monitor and maintain the ration between the resonant frequencies. The drive mode is run in closed-loop, providing a method to feedback the nonlinearity to the system for the desirable sensitivity and bandwidth of the oscillator.

In other embodiments that implement the nonlinear coupling micro-electro-mechanical system (MEMS) devices are disclosed. In one sample design, the MEMS devices are actuated using electrostatic force and sensing is capacitive. The drive mode oscillator is excited using a signal source. The desired harmonic of the excitation signal (i.e., the second harmonic for 2:1 resonance) can be produced electronically and used as reference for the demodulation of signal from the sense mode. In case of electrostatic actuation and sensing, a DC source is often needed to linearize the actuation force or to enable direct measurement of electrode displacements for the sense mode.

The drive mode can be operated at preset amplitude and the phase difference between the drive and the sense mode can be locked for the proper and real-time tuning of the system. The first natural frequency of the sense direction is fₛₑₙₛₑ in the y-direction and the first natural frequency of the drive mode oscillator is 2 fₛₑₙₛₑ=f_{drive} in the x-direction (as shown in FIG. 2).

Given that the Coriolis force appears at 180-degrees phase difference of the driving force, a control mechanism can be implemented to maintain the phase difference locked at the desired value, adjusting the resonant frequencies. The feedback loop can be implemented to suppress the undesirable effects in the sense direction and further amplify the signal-to-noise ratio.

Furthermore, when using nonlinear feedback the gain and bandwidth of the sense mode can be manipulated such that the sensitivity of the response is more robust. Controlling the response of the system by feeding back nonlinear terms also reduces the necessary driving voltages, consequently decreasing parasitic contamination of electrical signals and improves the sensor power consumption.

A general mathematical model that can be used to model the Coriolis vibratory gyroscope having an internal resonance is presented first along with the analysis of the nonlinear gyroscopic system. Various embodiments are presented to demonstrate the application of the invention.

Principles of Operation

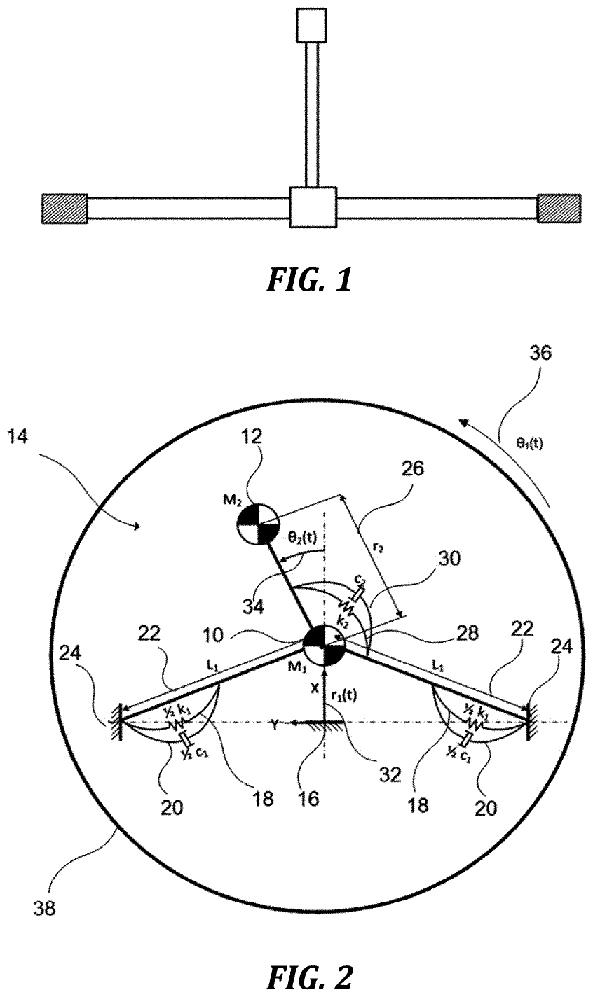

The detailed principle of operation of the device in explained first. The design approach used in the disclosed embodiments is explained by describing the dynamics of the design, after which several design embodiments based on the theory are described. FIG. 1 is a schematic of the principle structure of an internally resonant Coriolis vibratory gyroscope device disclosed herein. The basic device illustrated in FIG. 1 includes a first mass 10 coupled to a second mass 12 via a torsional spring 28. The first mass 10 is further coupled to fixed ends 24 by torsional springs 18. FIG. 2 is the schematic of a representative embodiment showing the dynamical model of the internally resonant structure in FIG. 1. The indicated model 14 operates on the principle of 2:1 (two-to-one) internal resonance.

While the ratio of 2:1 internal resonance is discussed throughout, it will be appreciated that minor deviation from this exact ratio still results in a functional device. Accordingly, as used herein, any mention of a 2:1 ratio indicates a ratio of from 1.9:1 to 2.1:1.

How close to 2:1 (e.g., how close to 2.000:1) is necessary depends on the damping ratio (i.e. quality factor (QF) at each mass's natural frequency). For example, with higher QF (i.e. lower damping) the ratio has to be closer to 2:1 (e.g., 2.01:1). With lower QF (i.e. higher damping) the ratio 2:1 can be more tolerant (e.g., 2.3:1).

Practically speaking, the systems with frequency ratios between 1.9 and 2.1 can cause transfer of energy between structural modes, and this effect can be significantly affected by excitation amplitude. In other words, for the ratios far from 2:1, larger forcing amplitudes are required. One unique characteristic of the presently disclosed devices is that tuning to an exact 2:1 ratio is not necessary because ratios between 1.9 and 2.1 can still lead to nonlinear modal interaction and transfer of energy.

The masses 10 and 12 are two factor among several when defining the 2:1 ratio of internal resonances. Other factors include lengths, widths, thicknesses, materials, and spring constants. Essentially anything that will affect the natural frequencies of materials can be used to tune the ratios.

The model is a two degree-of-freedom (DOF) lumped mass-spring-damper system comprising two masses 10 and 12. The masses 10 and 12 are free to oscillate with respect to the fixed inertial reference frame (X, Y, Z) 16, in two orthogonal directions: the drive oscillation direction (X-axis) and the sense oscillation direction (Y-axis). The mass M₁ 10 is located symmetrically at a distance 22 from fixed ends 24, and is supported by torsional springs 18. The mass M₂ 12 is located at a distance 26 from the mass 10, coupled by one or more torsional springs 28 to the mass 10. The angular rotation of the mass 12 with respect to X-axis is introduced by an angle 34. 20 and 30 express the torsional damping of the masses 10 and 12, respectively.

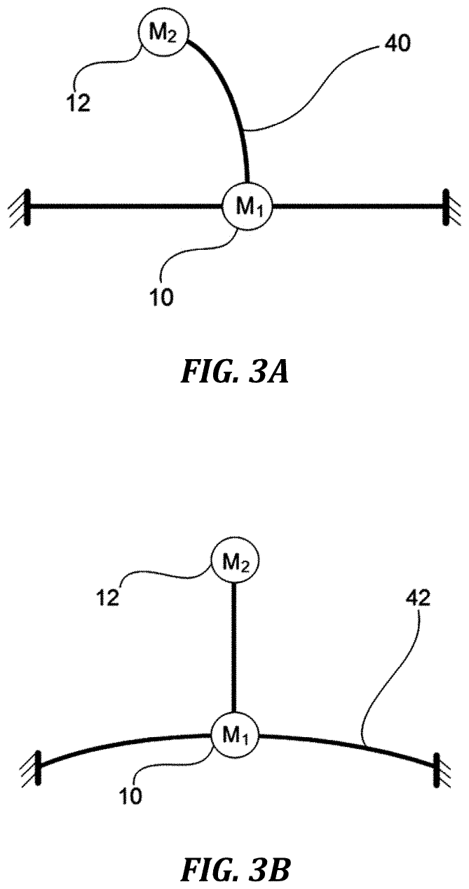

The first mode of vibration 40 is illustrated in FIG. 3A, where the displacement of the mass 10 is zero, and the mass 12 rotates by an angle 34 measured from the drives axis (i.e. X-axis). The second mode of vibration 42 is shown in FIG. 3B, where the mass 10 moves vertically along the drive axis. In this mode, the mass 12 also moves with no rotation 34 about Z-axis.

The cubic nonlinearities can create other harmonics. As a special case the device described is designed at a 2:1 ratio using the quadratic nonlinearities. Due to 2:1 frequency ratio between the drive mode (2fₛₑₙₛₑ) 42 and sense mode (fₛₑₙₛₑ) 40, and the presence of nonlinear coupling terms in the equations of motion, internal resonance will occur. Exciting the mass 10 into resonance at the higher frequency (fₛₑₙₛₑ) 42 will induce the vibration of the mass 12 at the lower frequency (fₛₑₙₛₑ) 40 provided the drive and the sense modes are coupled through quadratic nonlinearities and therefore interact through two-to-one internal resonance.

Dynamics of the Structure

The equations of motion of the two-DOF (degrees of freedom) dynamical system shown in FIG. 2 are obtained by using Lagrangian formulation. The generalized coordinates to describe the state of the system are specified as 32 and 34. The velocity vectors of 10 and 12 are defined as

\vec{v}_{M}_{₁}+\dot{r}₁\hat{ι}+r₁\dot{θ}₁Ĵ (1)

\vec{v}_{M}_{₂}=(\dot{r}₁−r₂(\dot{θ}₁+\dot{θ}₂) sin θ₂)\hat{ι}+(r₁\dot{θ}₁+r₂(\dot{θ}₁+\dot{θ}₂) cos θ₂)Ĵ (2)

where \hat{ι} and Ĵ are the unit vectors of the X and Y coordinate frame 16, respectively. Hence, the kinetic and potential energies of the system are computed and substituted into the Lagrange's equations along with a proper dissipation function in the form

$${F}_{d} = \frac{1}{2} ( \frac{{C}_{1}}{{L}_{1}^{2} ( 1 - {( \frac{{r}_{1}}{{L}_{1}} )}^{2} )} ) {\dot{r}}_{1}^{2} + \frac{1}{2} {C}_{2} {\dot{θ}}_{2}^{2} \qquad ( 3 )$$

The equations of motion is derived as follows

$$[ \begin{matrix}{M}_{1} + {M}_{2} & - {M}_{2} {r}_{2 } sin {θ}_{2} \\ - {M}_{2} {r}_{2} sin {θ}_{2} & {M}_{2} {r}_{2}^{2}\end{matrix} ] [ \begin{matrix}{\ddot{r}}_{1} \\ {\ddot{θ}}_{2}\end{matrix} ] + [ \begin{matrix}\frac{{C}_{1}}{{L}_{1}^{2} - {r}_{1}^{2}} & 0 \\ 0 & {C}_{2}\end{matrix} ] [ \begin{matrix}{\dot{r}}_{1} \\ {\dot{θ}}_{2}\end{matrix} ] + [ \begin{matrix}{K}_{1} & 0 \\ 0 & {K}_{2}\end{matrix} ] [ \begin{matrix}\frac{arcsin ( \frac{{r}_{1}}{{L}_{1}} )}{\sqrt{{L}_{1}^{2} - {r}_{1}^{2}}} \\ {θ}_{2}\end{matrix} ] = [ \begin{matrix}\begin{matrix}{M}_{2} {r}_{2} ( {\dot{θ}}_{2}^{2} + {Ω}_{rot}^{2} ) cos {θ}_{2} + 2 {M}_{2} {r}_{2} {Ω}_{rot} {\dot{θ}}_{2} cos {θ}_{2} + \\ ( {M}_{1} + {M}_{2} ) {r}_{1} {Ω}_{rot}^{2} + A sin ( {f}_{r} t )\end{matrix} \\ - {M}_{2} {r}_{2} {r}_{1} {Ω}_{rot}^{2} sin {θ}_{2} - 2 {M}_{2} {r}_{2} {\dot{r}}_{1} {Ω}_{rot} cos {θ}_{2}\end{matrix} ] \qquad 4 )$$

where A is the excitation amplitude, fᵣ is the excitation frequency, and Ωᵣₒₜ is the rotation rate applied to the structure.

The two terms 2M₂r₂Ωᵣₒₜ\dot{θ}₂ cos θ₂ and 2M₂r₂\dot{r}₁Ωᵣₒₜ cos θ₂ are the rotation-induced Coriolis forces, causing dynamic coupling between drive- and sense-mode proportional to input angular rate Ωᵣₒₜ. The quadratic nonlinear terms in the above equations of motion are due to the effect of rotation on the geometry of the structure. The satisfaction of two necessary conditions of internal resonance conditions, i.e., commensurability of the linear natural frequencies of the first two modes of vibration and the presence of quadratic nonlinear terms, confirms the nonlinear modal interaction causing enhanced energy transfer between structural modes.

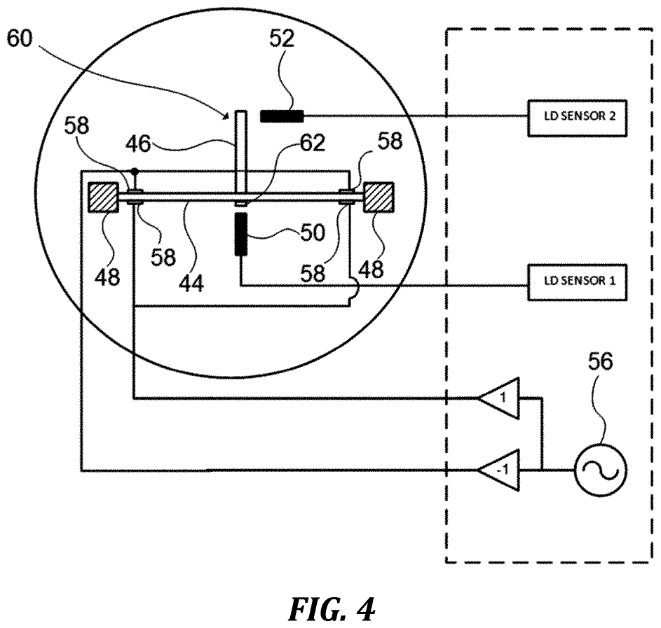

An embodiment illustrated in FIG. 4 is a T-shaped structure 60, comprising two beams, i.e. a doubly-clamped beam 44 and a clamped-free beam 46, and an added mass 62 to the beam 44. The added mass 62 is optionally used when further tuning towards the 2:1 ratio is required in a device. In conjunction with the main mass, it can also be used to control both frequencies. The T-shaped structure 60 can be modeled, and approximated as a 2-DOF lumped mass-spring-damper system 14 shown in FIG. 1. In the gyroscope structure 60, the doubly-clamped beam 44 (drive beam) is free to vibrate along the drive direction (X-axis) (i.e. the moment and shear force are zero), and the clamped-free beam 46 (sense beam) can move along the sense direction (Y-axis). The two modes of the system are nonlinearly coupled. That is the energy of the drive mode is transferred to the sense mode when the frequency ratio is 2:1.

As used herein, the term “clamp” refers to a fixed end where the deflection and derivative of deflection are zero.

In operation, the first step is to establish a 2:1 frequency ratio between the first two flexural modes of vibration. The geometric specifications of the drive beam 44, the sense beam 46, and the added mass 62 are determined ensuring 2:1 frequency ratio between the structural modes. The first and second modes of vibration are shown in FIGS. 3A and 3B respectively. In the first mode, the sense beam 46 bends, while the drive beam 44 is fixed. The second mode of vibration shows translation movement of the drive and sense beams (44 and 46) in the drive direction, without deflection of the sense beam 46 about Z-axis.

The actuation mechanism of the devices, as illustrated in FIGS. 3A and 3B, are to provide external sinusoidal force. In one embodiment piezoelectric patches were used for excitation. Referring again to FIG. 4, the actuation mechanism of the device is four piezoelectric patches 58 attached to the top and bottom surfaces of the drive beam 44 close to the fixed supports 48. The required voltages to drive piezo patches 58 are provided by an AC voltage source 56. The displacements of the drive beam 44 is measured by a laser displacement sensor 50 pointed at the added mass 62. Similarly, the deflection of the sense beam 46 is captured through another displacement sensor 52 pointed at the tip of the sense beam 46.

Other actuation mechanisms besides piezos that can be used include an electromagnetic shaker. Generally, any electrostatic, electromagnetic, or thermal method can be used, as long as it generates the necessary oscillation.

Sensing the displacement of the drive beam can be accomplished using any known or future developed methods. Laser displacement and capacitive sensing are discussed herein as exemplary sensing methods. Additional methods include strain gauges, electromagnetic sensors, resistive sensors, and optical sensors.

Upon actuation of the internally resonant gyroscope 60 at the higher mode resonance frequency (fᵣ≈2 fₛₑₙₛₑ) 42, the drive beam 44 is forced to resonate, while the vibrational energy is transferred into the sense beam due to 2:1 internal resonance. The quadratic nonlinear terms play the major role in this energy transfer. The sense-beam 46 oscillates at the frequency of (2 fₛₑₙₛₑ) 40, and grows until the steady-state condition is reached.

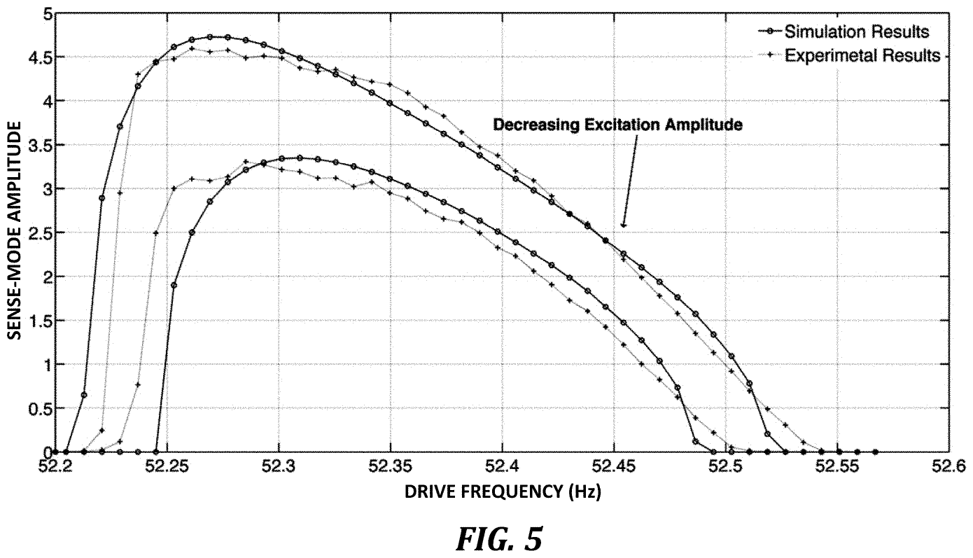

The robustness enhancement characteristics exhibited in the disclosed devices can be investigated through frequency sweeps of the sense mode responses. FIG. 5 illustrates the responses of the sense mode of the structure as a function of the driving frequency. As observed in FIG. 5, increasing the excitation amplitude results in larger bandwidth of the sense-mode 46. The larger bandwidth results in less sensitivity of the device to fabrication imperfections and variation in operating parameters. The sense response is less susceptible to the detuning of the drive and sense-mode frequencies. A good agreement between the experimental and the simulation results can be seen confirming the validity of the equations of motion.

The behaviour of the response is enhanced using a nonlinear feedback system. To observe the effects of nonlinear feedback terms the nonlinear quadratic and cubic terms can be fed back to the excitation signal. The existing nonlinear terms in the equation of motion are assigned a constant gain (Kᵢ) where the amplitude of the feedback is a fraction of the excitation amplitude.

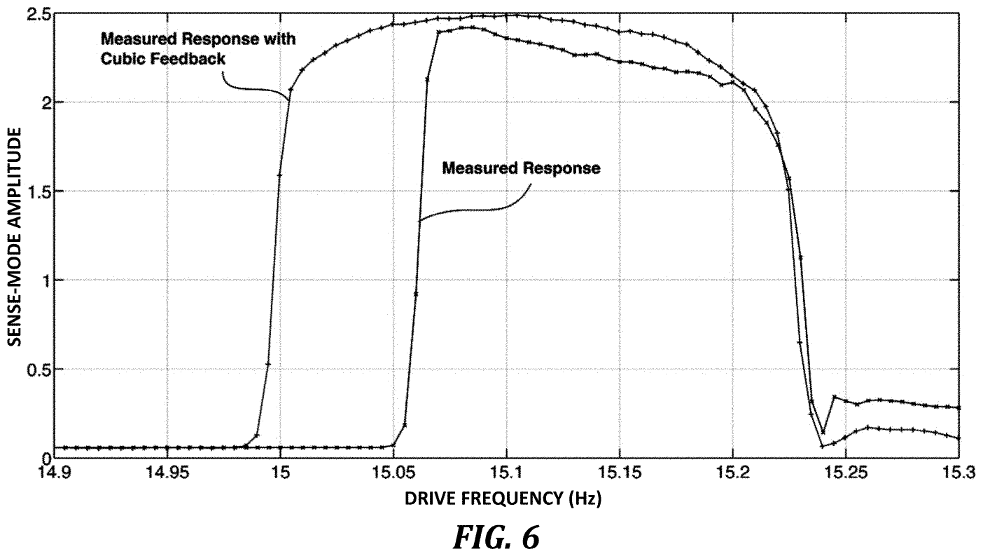

The feedback of the nonlinear term enhances the bandwidth of the sense response due to the characteristics of nonlinear dynamics. Due to the characteristics of nonlinear dynamics the feedback of the nonlinear term enhances the bandwidth of the sense response. It also modifies the shape and quality factor of the response when the drive and sense mode frequencies are detuned from 2:1 ratio. FIG. 6 illustrates the use of nonlinear feedback of a cubic term to enhance the bandwidth and gain of the response of a detuned T-structure. It is observed that the bandwidth of the response of the sense beam is increased significantly, while the shape of response improves in the sense that it becomes more flat.

With regard to specific frequencies used for the disclosed devices, typical resonant frequencies are in the 10 kHz to 10 MHz range. This range is typically for practical reasons related to fabrication, such as beam size, which limits mass size and therefore limits frequencies.

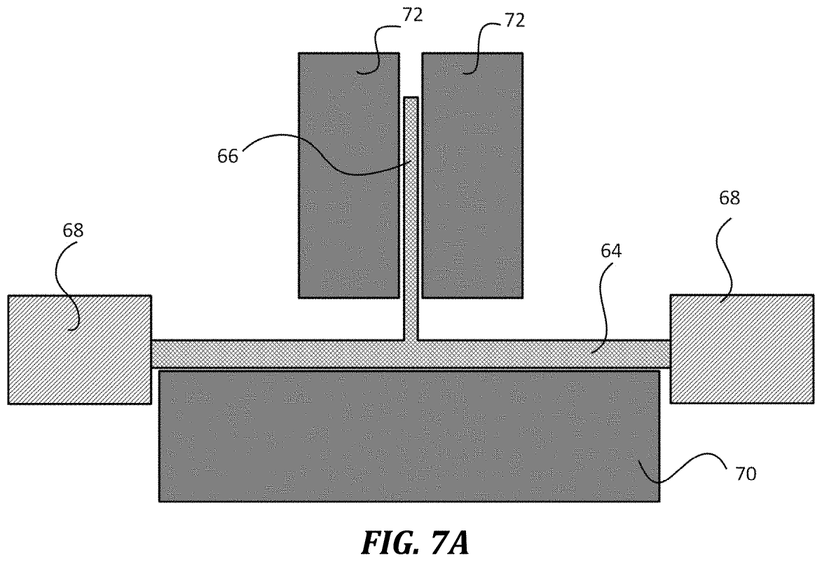

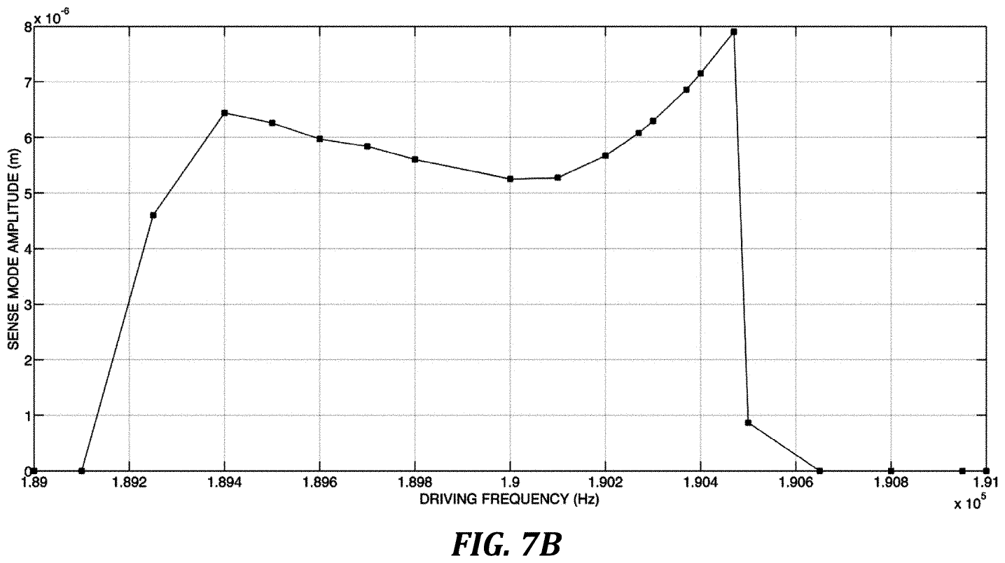

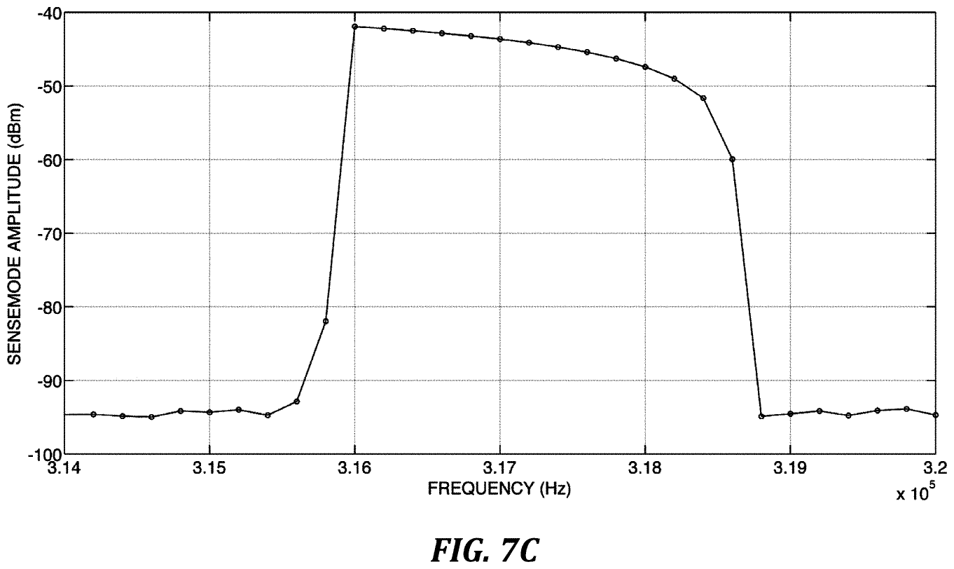

In another embodiment, illustrated in FIG. 7A, a T-shaped MEMS device structure is fabricated using a micromachining process. The structure of FIG. 7A includes a drive mode component 64 clamped at 68, and a sense mode component 66. The drive mode is electrostatically excited using the electrode 70, and a pair of sense electrodes 72 is used for differential capacitive sensing. As an indication of the internal resonance behaviour of the structure the frequency response simulation results of the MEMS structure from FIG. 7A is shown in FIG. 7B. The structure shown in FIG. 7A was also fabricated and the frequency response of the sense mode is shown in FIG. 7C. As both FIGURES illustrate the simulation and experimental response of the sense mode, the transfer of energy from drive to sense happens for a bandwidth of drive mode excitation at twice the frequency.

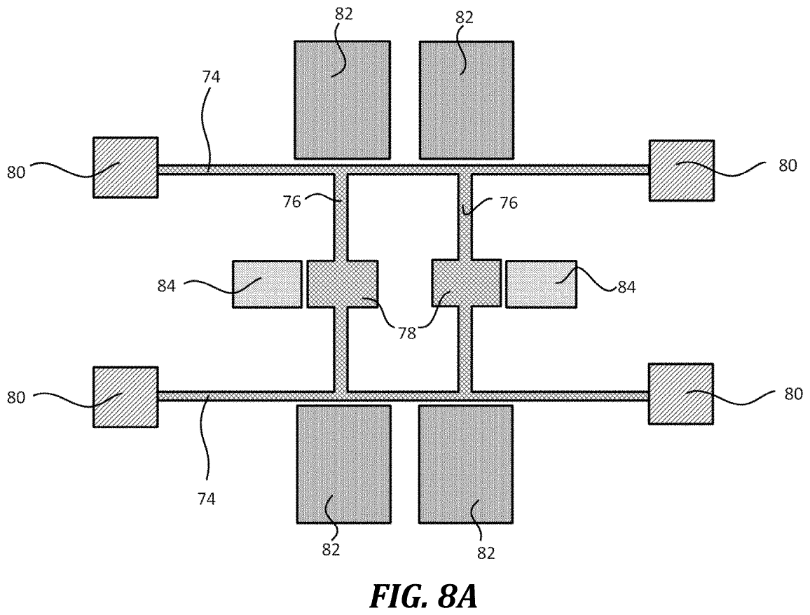

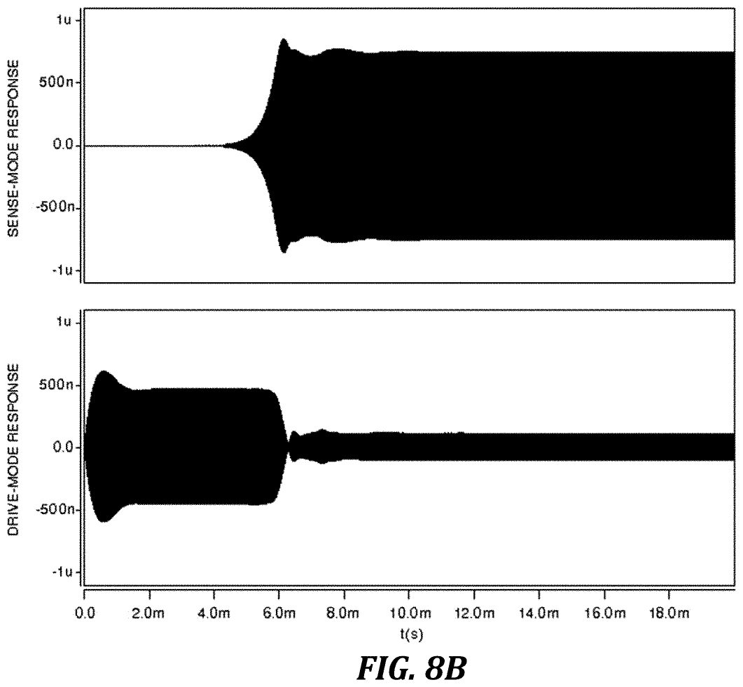

Yet another embodiment is presented in FIG. 8A as another internally resonant design. In this embodiment 76 is the primary drive mode component, where a proof mass 78 is added to tune the frequency ratio of the drive and sense to 2:1. The excitation signal is applied using the electrodes at 84. The sense mode component 74 is clamped on both sides at 80, with a pair of adjacent electrodes positioned at 82. FIG. 8B illustrates simulation results of this MEMS device, where the energy of the drive beam oscillator is transferred to the sense beam oscillator when the excitation frequency is 2fₛₑₙₛₑ.

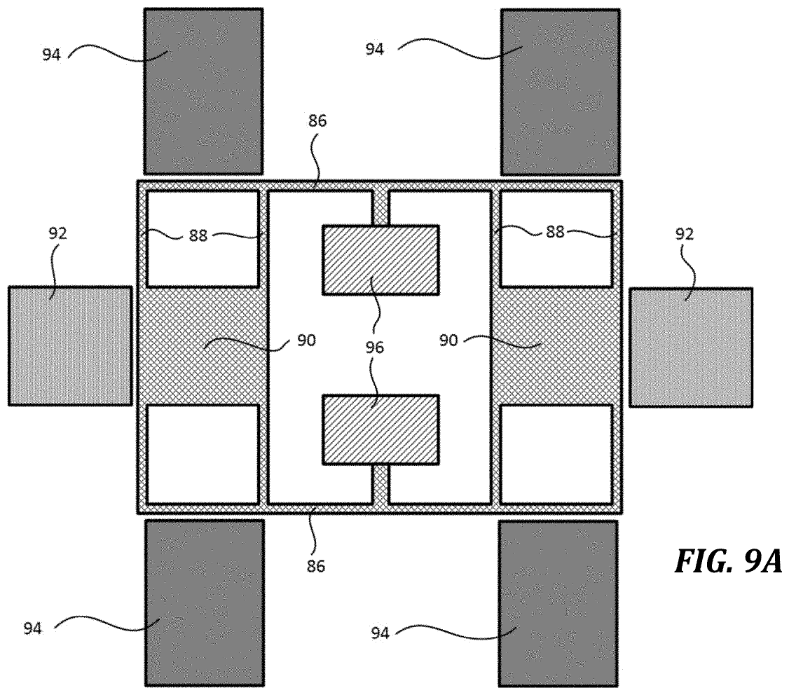

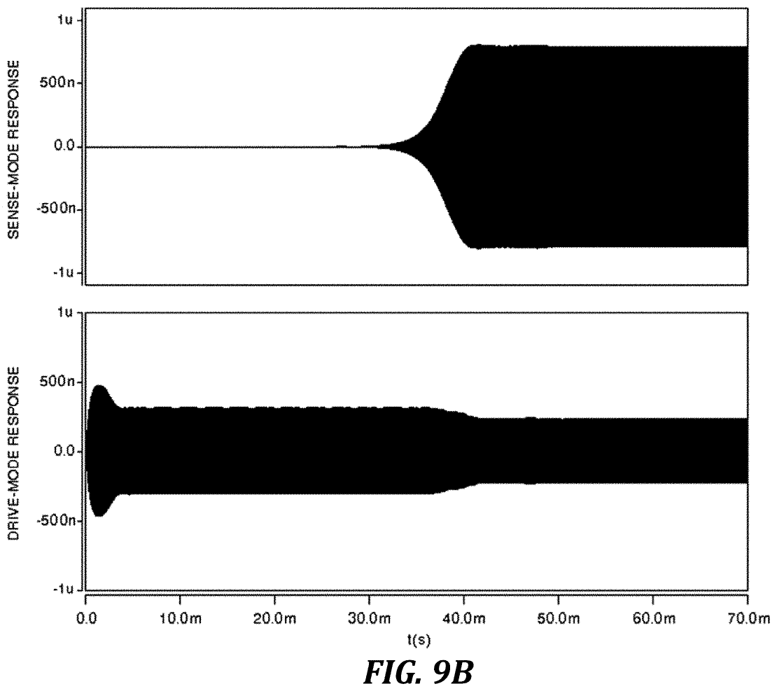

Yet another embodiment of a device is presented in FIG. 9A. In this embodiment the drive mode component includes two beams 88 connected at both ends to the sense mode component 86 and a mass 90 to tune the frequency ratio to 2:1. The sense mode component is supported in the middle at 96. The drive and sense component have adjacent electrode 92 and 94 respectively.

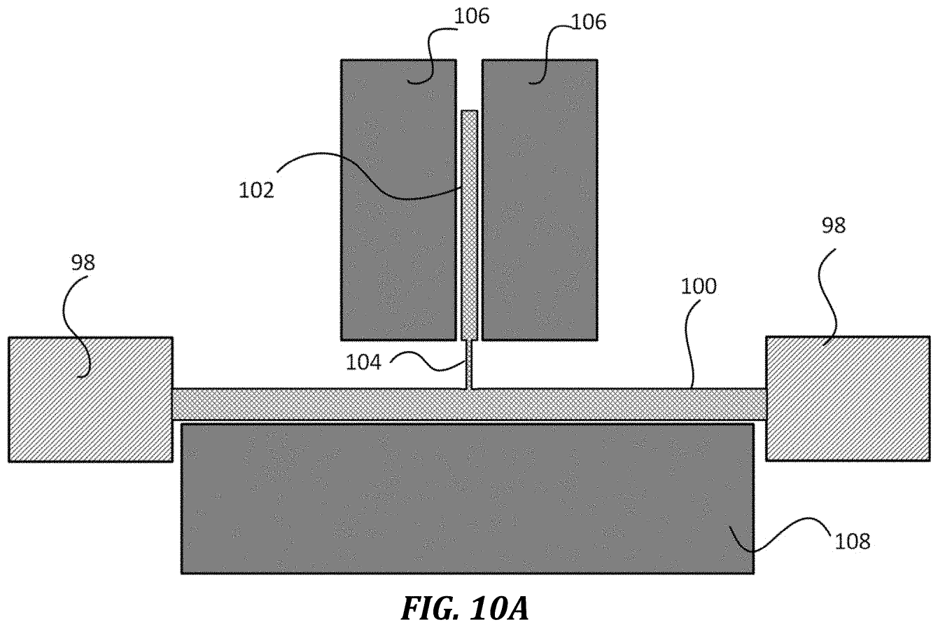

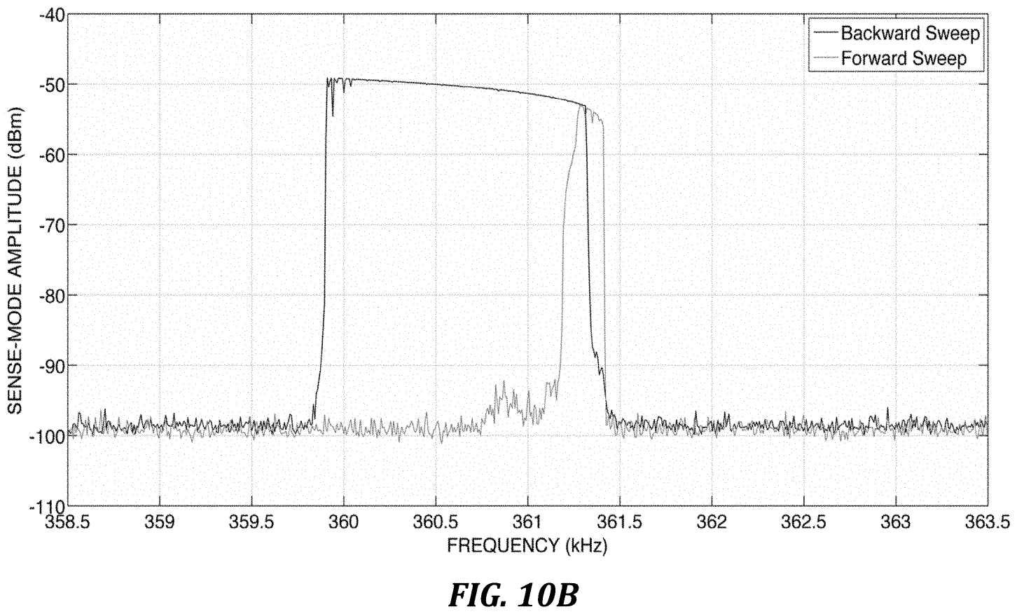

Yet another embodiment of a device is presented in FIG. 10A. In this embodiment the structure the T-shape structure is designed where the sense beam is modified such that the point 104, where the drive 100 and sense 102 beams are connected has less width compared to the rest of the sense 102 beam. This narrowing of the sense beam where it is connected to the drive mode beam increases the structural nonlinearities and can assist in the transfer of energy between coupled modes. The drive mode component is clamped at both ends 96. The drive electrode 108 and sense electrodes 106 are placed adjacent to the drive and sense mode components respectively.

With regard to fabrication of the MEMS devices disclosed herein, these MEMS device can be fabricated through a variety of silicon-based processes such as SOIMUMPS, PiezoMUMPS, etc. In these processes, silicon is the common material that basically constructs the main body of the device as well as actuation and detection mechanisms. The typical fabrication processes involved are silicon deposition, lithography, etching, and releasing of the structure. The general fabrication techniques are known—however the devices disclosed herein are not.

While illustrative embodiments have been illustrated and described, it will be appreciated that various changes can be made therein without departing from the spirit and scope of the invention.

The embodiments of the invention in which an exclusive property or privilege is claimed are defined as follows:

1. A micromechanical device configured to measure angular movement around at least one axis, the device comprising:
a suspended frame anchored at its corners;
a combination of one or more proof-masses that are connected to each other with beams, wherein the one or more proof masses are used for tuning on either side of the frame, and wherein one or more connections are included on one or more sides of the frame;
a clamped-clamped beam and a second beam that is connected to a center of the clamped-clamped beam at one end and is free at the other end;
a structure having two distinct vibration modes that are nonlinearly coupled: a sense mode with sense mode frequency fₛₑₙₛₑ and a drive mode with drive mode frequency f_{drive};
one or more excitation elements having a vibration source configured to force the structure into oscillations and to produce vibrations in a mass at the drive mode; and
a vibration detector configured to detect amplitude and phase of vibrations of the sense mode frequency,
wherein the sense mode at the sense mode frequency fₛₑₙₛₑ and the drive mode at the drive mode frequency f_{drive} are nonlinearly coupled such that a nonlinear modal interaction between the drive mode and the sense mode is enhanced through internal resonance, and
wherein an external angular rate is measured by monitoring changes of vibration parameters of the sense mode.

2. The device of claim 1, wherein two distinct vibration modes that are nonlinearly coupled have a quadratic nonlinearity.

3. The device of claim 1, wherein two distinct vibration modes that are nonlinearly coupled have a cubic nonlinearity.

4. The device of claim 1, wherein the frequency of the sense mode fₛₑₙₛₑ is half the frequency of the drive mode f_{drive} or twice the frequency of the drive mode f_{drive}.

5. The device of claim 1, wherein the frequency of the drive mode f_{drive} is f_{drive}≈n·fₛₑₙₛₑ where n=2, 3, . . . , and wherein the drive mode and the sense mode are coupled through nonlinear terms of order n.

6. The device of claim 1, wherein at least one of the frequencies, amplitudes or phases are tuned mechanically, through an electronic closed-loop feedback, or through a combination thereof.

7. The device of claim 1, wherein the drive mode is excited using one or more piezoelectric actuators, one or more electrostatic actuators, or using a thermal method.

8. The device of claim 1, wherein the vibration of the sense mode is detected using one or more optical velocity sensors, or one or more optical displacement sensors.

9. The device of claim 1, wherein the vibration of the sense mode is detected using one or more capacitive sensors.

10. The device of claim 1, wherein the vibration of the sense mode is detected using one or more piezoelectric sensors, or one or more piezoresistive sensors.

11. The device of claim 1, wherein a drive mode oscillator is configured to operate in an open loop.

12. The device of claim 1, wherein a drive mode oscillator is configured to operate in a closed loop.

13. The device of claim 1, wherein a sense mode signal is used to detect a rate of rotation, and wherein a relative amplitude of the sense signal is enhanced relative to the drive frequency using filters.

14. The device of claim 1, wherein a nonlinearity between the two modes is enhanced through feedback.

15. The device of claim 1, wherein the device is configured to increase a bandwidth, enhance a shape of a flat region of the sense mode or increase a quality factor of the device using nonlinear feedback.

16. A gyroscope incorporating the device of claim 1, wherein the gyroscope is configured to detect the rate of rotation about an axis, and wherein a flat region appears in a frequency-response or in a frequency-amplitude plot of the sense mode around a natural resonant frequency of the drive mode.
